(19) United States
(12) Patent Application Publication
(10) Pub. No.: US 2010/0325658 A1
(43) Pub. Date: Dec. 23, 2010

(54) TARGETED ADVERTISEMENTS USING AN EDGE QAM

(75) Inventors: John A. Schlack, Quakertown, PA (US); Bruce R. Bradley, Wayne, PA (US)

Correspondence Address: Motorola, Inc., 600 North US Highway 45, W4 - 39Q, Libertyville, IL, 60048-5343, US

(73) Assignee: GENERAL INSTRUMENT CORPORATION, Horsham, PA (US)

(21) Appl. No.: 12/489,005

(22) Filed: Jun. 22, 2009

(51) Int. Cl. H04N 7/025

(52) U.S. Cl. 725/32

(57) ABSTRACT

An edge quadrature amplitude modulator (QAM) including an input module configured to receive a switched digital video (SDV) stream containing at least one ad opportunity, at least one ad stream containing a plurality of alternative advertisements, and an ad playlist that contains a list of one or more of the plurality of alternative advertisements to be inserted into the SDV stream. The edge QAM also includes an ad insertion module configured to detect the at least one ad opportunity in the SDV stream and to insert one or more of the plurality of alternative advertisements in the at least one ad stream based upon the ad playlist into the SDV stream at the at least one ad opportunity and an output module configured to send the SDV stream and the one or more alternative advertisements to at least one STB.

### BACKGROUND

Switched digital video (SDV) refers to an arrangement in which television channels are only switched onto the network when they are requested by one or more subscribers, thereby allowing system operators to save bandwidth by not delivering unviewed television channels over their distribution network. Thus, a SDV channel is only available when requested by one or more authorized subscribers. In contrast, in conventional cable or satellite broadcast systems, every television channel consumes bandwidth whether or not it is being viewed by subscribers. SDV channels are known to be provided to subscribers in SDV streams, which are known to be shared among multiple viewers on the same service group. Alternately, SDV streams are known to be unicast, for instance, delivered through video on demand (VOD) to a single subscriber.

One way to support switched digital video is to utilize a SDV Manager to manage switched sessions. For each channel change, the subscriber will set up a switched session with the SDV Manager, which will determine if the requested channel is already being sent to the subscriber's service group. The subscriber's set top box (STB) will be instructed to join the existing broadcast session if the requested channel is available on the service group. If the requested channel is not available at the service group, the SDV Manager will instruct the edge devices to allocate resources required to provision the session. The edge device (e.g., a digital modulator such as a QAM modulator) dynamically joins the MPEG single program transport stream that carries the requested broadcast program (likely via IP multicast) and generates the MPEG multiple program transport stream onto its radio frequency (RF) output. As part of the session setup response message, the video tuning parameters such as frequency and MPEG program number are sent back to the STB to access the requested broadcast channel.

In addition, addressable advertising has been proposed to target a specific group of subscribers based on the demographics of the subscriber household through switching operations performed at the subscribers' STBs. Operators of cable systems are interested in delivering addressable advertising as a way to increase revenue received from local advertising and to stop the flow of advertising dollars from television to other media, such as the Internet.

Conventional methods of providing addressable advertising typically require changes to the set top code which instructs the STB to tune to an alternative ad that has been positioned on an alternative video channel. Changing STB software is often costly and time consuming due to the variety of STBs deployed in a given system. Some STBs are incapable of this form of addressable advertising due to hardware limitations, such as lack of code space, slow tuning, and lack of processing power. Additionally, the ad streams containing the alternative advertising consume RF bandwidth for each alternative ad, which is in limited supply. This problem is even more significant when the program and alternative advertisements are a higher data rate such as high definition.

Providers of multimedia content typically employ conventional edge quadrature amplitude modulators (QAMs) to provide both video on demand and SDV streams to subscribers. Conventional edge QAMs are typically directed toward a particular service group, providing a narrow cast bandwidth for delivering content to subscribers while preserving bandwidth. A typical QAM provides an Internet Protocol (IP) video input and an RF video output.

Programs into a particular service group may be turned on and off using an Internet Protocol (IP) such as internet group multicast protocol (IGMP). When a subscriber selects a particular program, a message is often sent to a conventional edge QAM from the SDV manager or alternately, from an Edge Resource Manager (ERM) directing the conventional edge QAM to join a particular multicast and to bind the information on that multicast to a selected frequency and MPEG program. The STB is then directed to the selected frequency and program at which the content required is located.

### SUMMARY

Disclosed herein is an edge quadrature amplitude modulator (QAM) that includes an input module configured to receive a switched digital video (SDV) stream containing at least one ad opportunity, to receive at least one ad stream containing a plurality of alternative advertisements, and to receive an ad playlist that contains a list of one or more of the plurality of alternative advertisements to be inserted into the SDV stream. The edge QAM also includes an ad insertion module configured to detect the at least one ad opportunity in the SDV stream and to insert one or more of the plurality of alternative advertisements in the at least one ad stream based upon the ad playlist into the SDV stream at the at least one ad opportunity. The edge QAM further includes an output module configured to send the SDV stream and the one or more alternative advertisements to at least one set top box.

Also disclosed herein is a system for providing targeted advertisements to at least one set top box (STB). The system includes at least one edge quadrature amplitude modulator (QAM) configured to provide a switched digital video (SDV) stream to the at least one STB, wherein the SDV stream contains at least one ad opportunity. The system also includes a groom and splice component configured to supply the SDV stream to the at least one edge QAM, an ad decision service configured to generate an ad playlist for the at least one STB, an ad server configured to provide at least one ad stream containing the plurality of alternative advertisements to the groom and splice component, wherein the groom and splice component is further configured to supply the at least one ad stream to the at least one edge QAM. In addition, the at least one edge QAM is further configured to detect the at least one ad opportunity in the SDV stream, to insert one or more of the plurality of alternative advertisements in the at least one ad stream into the SDV stream based upon the ad playlist at the at least one ad opportunity and to output the SDV stream and the one or more alternative advertisements to the at least one STB.

Further disclosed herein is a method of providing targeted advertisements to at least one set top box (STB) from an edge quadrature amplitude modulator (QAM). In the method, a switched digital video (SDV) stream containing at least one ad opportunity is received; at least one ad stream containing a plurality of alternative advertisements is received; an ad playlist that contains a list of one or more of the plurality of alternative advertisements to be inserted into the SDV stream is received; the at least one ad opportunity is detected in the SDV stream; one or more of the plurality of alternative advertisements in the at least one ad stream based upon the ad playlist is inserted into the SDV stream at the at least one ad opportunity; and the SDV stream with the inserted one or more alternative advertisements is outputted to at least one STB.

Still further disclosed is a computer readable storage medium on which is embedded one or more computer programs implementing the above-disclosed method of providing targeted advertisements to at least one set top box (STB) from an edge quadrature amplitude modulator (QAM).

### BRIEF DESCRIPTION OF THE DRAWINGS

Embodiments are illustrated by way of example and not limited in the following figure(s), in which like numerals indicate like elements, in which:

FIG. 1 illustrates a block diagram of content delivery system, according to an embodiment of the invention;

FIG. 2 illustrates a block diagram of an edge QAM, according to a further embodiment of the invention;

FIG. 3 illustrates a diagram of multiple ad streams and an SDV stream that may be multicast on designated IP addresses and ports, according to an embodiment of the invention;

FIG. 4 illustrates a flow diagram of a method of providing targeted advertisements to at least one set top box from an edge QAM, according to an embodiment of the invention; and

FIG. 5 shows a block diagram of a computing apparatus configured to implement or execute one or more of the processes depicted in FIGS. 1-4.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

The term “SDV stream,” as used herein, refers to a video stream delivered over an SDV network. The SDV stream may contain program segments and default advertisements.

The term “advertisement,” as used herein, refers to a public notice, for instance, that is directed to particular goods or services.

The term “ad pod,” as used herein, refers to a commercial break in a broadcast program, such as, in an SDV stream. An ad pod is comprised of at least one space for an advertisement to be broadcast during the commercial break. In addition, an ad pod may have sufficient space for multiple consecutive advertisements to be inserted into the SDV stream.

The term “ad opportunity,” as used herein, refers to a point in the SDV stream at which alternative advertisements, such as advertisements targeted to particular individuals or groups of individuals, may be inserted in place of the default advertisements in the SDV stream.

The term “ad stream,” as used herein, refers to a stream containing the alternative advertisements that may be inserted into the SDV stream. The ad stream may be a multicast stream or alternately a unicast stream.

The term “ad opportunity marker,” as used herein, refers to a marker embedded within the SDV stream that indicates that an ad opportunity is soon approaching. The ad opportunity marker may also indicate the duration of the upcoming ad opportunity.

The term “ad playlist,” as used herein, refers to a table or other arrangement containing program segments and alternative advertisements that are to be viewed over a channel at a set-top box. The ad playlist also contains corresponding IP addresses for an edge QAM to switch to in order to access a program segment or alternately an advertisement.

The term “output stream,” as used herein, refers to a modified SDV stream sent from an edge QAM to a set top box. The modified SDV stream may contain alternative advertisements inserted into the SDV stream by an edge QAM.

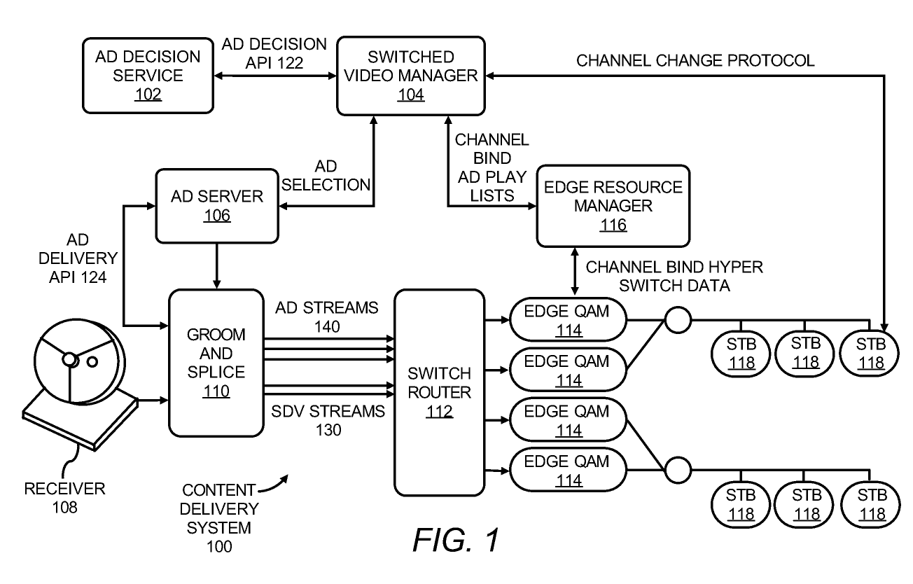

With reference first to FIG. 1, there is shown a block diagram of a content delivery system 100, according to an embodiment. It should be understood that the content delivery system 100 depicted in FIG. 1 may include additional components and that some of the components described herein may be removed and/or modified without departing from a scope of the content delivery system 100.

As depicted in FIG. 1, the content delivery system 100 includes an ad decision service 102, a switched digital video manager (SDV) 104, an ad server 106, a receiver 108, a groom and splice component 110, a switch router 112, a plurality of edge quadrature amplitude modulators (QAMs) 114, an edge resource manager (ERM) 116, and a plurality of set top boxes (STBs) 118. The ad decision service 102 communicates with the SDV manager 104 using an ad decision API 122. In addition, the ad server 106 communicates with the groom and splice component 110 using an ad delivery API 124. The edge QAMs 114 may also communicate with the groom and splice component 110 using the ad delivery API 124.

The receiver 108 is configured to receive SDV channels from content providers, for instance, via a satellite broadcast from the content providers. In addition, the receiver 108 is configured to relay streams containing the SDV channels to the groom and splice component 110. The groom and splice component 110 may prepare the SDV streams for delivery over a SDV network by transcoding, rate clamping, conversion from MPTS (multi program transport stream) to SPTS (single program transport stream), and encryption, etc. of the SDV streams.

The ad server 106 also supplies a plurality of ad streams 140 to the groom and splice component 110. As discussed above, the ad streams 140 contain alternative advertisements that may be inserted into the SDV streams at ad opportunities contained in the SDV streams. Thus, for instance, and as discussed in greater detail herein below, the default advertisements contained in the SDV streams may be replaced with one or more of the alternative advertisements contained in the ad streams 140 when ad opportunities in the SDV streams are identified, to thereby provide subscribers with targeted advertisements.

The groom and splice component 110 outputs one or more SDV streams 130 containing the SDV channels to the switch router 112 over an Internet Protocol (IP) network. The groom and splice component 110 also outputs the ad streams 140 to the switch router 112 over the IP network. In one regard, the groom and splice component 110 substantially ensures that the ad streams 140 and SDV streams 130 arrive at the switch router 112 such that the alternative advertisements may be inserted into the SDV streams 130 at the appropriate ad opportunities.

According to an embodiment, the SDV streams 130 and/or the ad streams 140 comprise IP multicasts from the groom and splice component 110, which are joined by one or more of the edge QAMs 114 through the switch router 112. According to another embodiment, the groom and splice component 110 directly communicates the SDV streams 130 and/or the ad streams 140 to one or more of the edge QAMs 114 through IP unicast connections.

In addition, the edge QAMs 114 are connected to the switch router 112, which enables the edge QAMs to receive one or more of the SDV streams 130 and/or ad streams 140 at any given time by connecting to particular IP addresses of the SDV streams 130 and/or ad streams 140.

The edge QAMs 114 are configured to receive selected ones of the SDV streams 130 based upon instructions received from the STBs 118. More particularly, when an STB 118 is directed towards a particular SDV channel, an SDV Client (not shown) located in the STB 118 sends a channel change message to the switched video manager 104, requesting the specific channel. The switched video manager 104 may direct the STB 118 to tune to the specific channel if the channel is already being delivered to that service group.

Alternately, in instances where the requested SDV channel is not currently being delivered to the service group of the STB 118, the switched video manager 104 directs the ERM 116 to cause the edge QAM 114 that is currently outputting to the STB 118 to connect to the IP address of the SDV stream containing the requested SDV channel. As such, the edge QAM 114 binds the service group of STBs 118 to the requested SDV channel. In addition, the switched digital video manager 104 tracks which of the STBs 118 are receiving which of the SDV streams 130 through the edge QAMs 114.

The edge QAMs 114 are also configured to receive an ad playlist from the switched video manager 104, which receives the ad playlist from the ad decision service 102. The ad playlist comprises a table or other arrangement containing program segments and alternative advertisements that are to be streamed to the STBs 118 connected to a particular edge QAM 114. As such, the ad playlist 210 defines the one or more alternative advertisements that are to be inserted into a particular SDV stream 130 for one or more STBs 118. According to an example, the ad decision service 102 may identify the alternative advertisements to be included in the ad playlist based upon one or more of, for instance, the viewing habits of particular subscribers, the geographic locations of the subscribers, the shopping habits of the particular subscribers, the age groups of particular subscribers, etc.

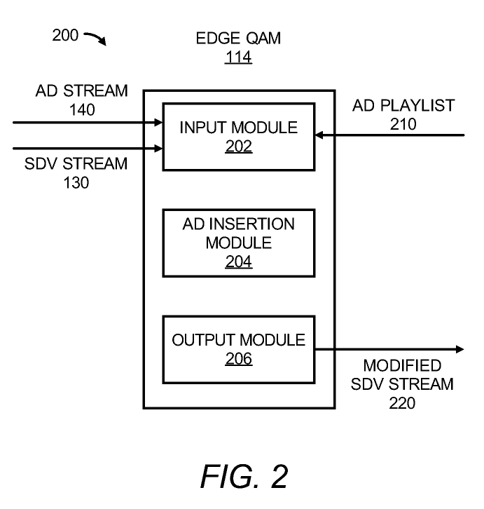

According to an embodiment of the invention, the edge QAMs 114 are configured to modify one or more of the SDV streams 130 by inserting targeted advertisements from the ad streams 140 into the SDV stream(s) 130 that are communicated to the STBs 118, based upon the information contained in the ad playlists. Various operations that the edge QAMs 114 perform with respect to modifying the SDV stream(s) 130 are described with respect to the diagram depicted in FIG. 2.

FIG. 2, more particularly, depicts a block diagram 200 of an edge QAM 114, according to an embodiment of the invention. It should be understood that the edge QAM 114 depicted in FIG. 2 may include additional components and that some of the components described herein may be removed and/or modified without departing from a scope of the edge QAM 114.

As depicted in FIG. 2, the edge QAM 114 includes an input module 202, an ad insertion module 204, and an output module 206. The modules 202-206 may comprise software modules, hardware modules, or a combination of software and hardware modules. Thus, in one embodiment, one or more of the modules 202-206 comprise circuit components. In another embodiment, one or more of the modules 202-206 comprise software code stored on a computer readable storage medium, which is executable by a processor.

In any regard, the input module 202 is configured to receive at least one of the ad streams 140 and at least one of the SDV streams 130 from the switch router 112. More particularly, for instance, the input module 202 is configured to connect to the particular IP address of the ad stream(s) 140 and the SDV stream(s) 130 through the switch router 112. In addition, the input module 202 is configured to receive an ad playlist 210 from the switched video manager 104, as also discussed above. The input module 202 may receive the ad playlist 210 at predetermined intervals of time or the input module 202 may be configured to request the ad playlist 210.

More particularly, for instance, and with reference back to FIG. 1, one or more of the edge QAMs 114 may request an ad playlist 210 from the ad decision service 102 when a subscriber switches to channels with alternative advertising opportunities. Alternately, the switched video manager 104 may proactively request the ad playlist 210 from the ad decision service 102 when the subscriber switches to channels with advertising opportunities using the ad decision API 122. The switched video manager 104 specifies various channel, subscriber, ad criteria including the channel identifier, subscriber identification, ad opportunity time, and number and duration of advertisements (if known). In any regard, the ad decision service 102 returns the ad playlist 210 to the switched video manager 104. An example ad decision API 122 is SCTE-130 (formerly known as DVS 629).

The switched video manager 104 then distributes the ad playlist 210 for each of the SDV streams 130 to the edge resource manager 116 (or directly to the edge QAMs 114) and to the ad server 106. The switched video manager 104 may respond in real time to ad playlist 210 requests from the edge QAMs 114 and edge resource manager 116. This may be necessary when an ad opportunity arises and the switched video manager 104 did not preposition the ad playlist 210 on the respective devices.

In response to an ad delivery request, the ad server 106 examines the SDV channel with the ad opportunity and determines if the ad playlist 210 has been compiled. If the ad playlist 210 has not been compiled, the ad server 106 may reject the request or the ad server 106 may query the switched video manager 106 for advertisements to deliver for the ad opportunity. After the ad server 106 has the ad playlist 210, the ad server 106 begins streaming the advertisements at the splice time to the groom and splice component 110 shortly before the splice time of the advertisement.

When the groom and splice component 110 receives the ad stream 140 from the ad server 106, the groom and splice component 110 transmits the ad stream 140 via IP multicast or alternately via IP unicast to the switch router 112. The groom and splice component 110 generally ensures that the advertisements contained in the ad streams 140 are timed to arrive at the edge QAMs 114 at the same time as the ad opportunities in the SDV streams 130.

When the groom and splice component 110 detects an ad opportunity marker (SCTE-35 splice_insert command, for example), the groom and splice component 110 uses an ad delivery API 124 to request the advertisements from the ad server 106. Information that may be included in the ad delivery API 124 includes the SDV channel identifier, splice time, number of advertisements in the ad opportunity, and duration of each advertisement. One example of the ad delivery API 124 is SCTE-30, which is the Digital Program Insertion Splicing API.

With reference back to FIG. 2, the ad insertion module 204 monitors each received stream for the ad opportunity marker. When the ad opportunity arrives, the ad insertion module 204 determines if an ad playlist 210 has been received for the ingested SDV stream 130 associated with that SDV channel. Since an SDV channel may be watched across multiple service groups simultaneously, the ad insertion module 204 requires an ad playlist 210 for each output stream. If any ad playlist 210 is missing, the ad insertion module 204 may abort the ad insertion for the output streams associated with the missing ad playlist 210. Alternatively, the ad insertion module 204 may request an ad playlist 210 from the ERM 116 (or directly from the switched video manager 104).

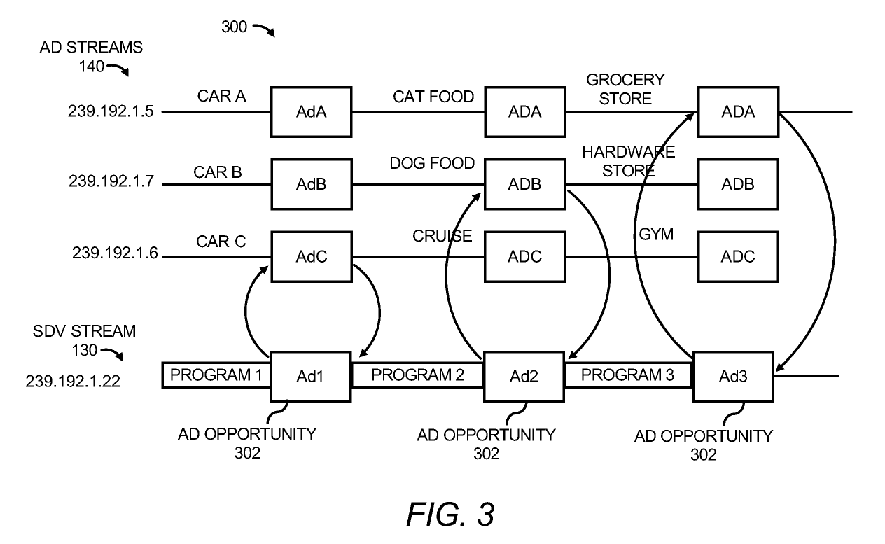

Turning now to FIG. 3, there is shown a diagram 300 of multiple ad streams 140 and an SDV stream 130 that may be multicast on designated IP addresses and ports. As shown therein, the ad insertion module 204 is configured to receive the SDV stream 130, and more particularly, segments of a program containing a plurality of ad opportunities 302. The ad opportunities 302 conventionally contain default advertisements inserted into the SDV stream 130 by the content providers. As discussed herein, however, the ad insertion module 204 inserts alternative, targeted, advertisements into one or more of the ad opportunities 302, as indicated by the arrows in FIG. 3.

More particularly, the ad insertion module 204 is configured to insert selected alternative advertisements from one or more of the ad streams 140 during the ad opportunities 302. In addition, the ad insertion module 204 is configured to insert the alternative advertisements based upon data contained in the ad playlist 210 for that edge QAM 114. The output module 206 is configured to output a modified SDV stream 220 containing both the program content contained in the SDV stream 130 and alternative advertisements contained in ad streams 140. Alternatively, the output module 206 is configured to output the SDV stream 130 and the alternative advertisements substantially as the input module 202 receives the SDV stream 130 and the ad streams 140. In this regard, the ad insertion module 204 may operate in near real-time to insert the alternative advertisements into the ad opportunities 302 in the SDV stream 130.

An example of an ad playlist 210 is shown in Table 1 below. It should be understood that the IP addresses and the advertisements depicted in FIG. 2 and discussed below with respect to TABLE 1 are for purposes of illustration only and should thus not be construed as limiting the present invention in any respect.

TABLE 1

| Viewing | edge QAM action |
|---|---|
| Program Segment 1 | Join Multicast 239.192.1.22 |
| Car C | Join Multicast 239.192.1.6 |
| Program Segment 2 | Join Multicast 239.192.1.22 |
| Dog Food | Join Multicast 239.192.1.7 |
| Program Segment 3 | Join Multicast 239.192.1.22 |
| Grocery Store | Join Multicast 239.192.1.5 |

The ad insertion module 204 is configured to detect the ad opportunity marker of an ad opportunity 302, which is embedded in the SDV stream 130, and to perform an internet group multicast protocol (IGMP) join to an alternative multicast address specified in the ad playlist 210, for example, multicast 239.192.1.6. In this example, the groom and splice component 110 times the communication of the ad streams 130 containing the advertisements to the switch router 112 to substantially coincide with the ad opportunities 302 in the SDV stream 130.

The durations of each of the ad opportunities 302 may be considered as ad pods. Although each of the ad pods has been depicted as including space for a single advertisement, one or more of the ad pods may have sufficient space for multiple advertisements. In addition, at the end of each ad pod, a trigger prompts the ad insertion module 204 to rejoin the SDV stream 130. In an embodiment in which the ad pod is comprised of multiple advertisements, the ad insertion module 204 may switch to alternative advertisements in multiple multicast addresses during an ad pod and may rejoin the SDV stream 130 at the end of the ad pod. By switching to different alternative multicast addresses from the ad streams 140 for each advertisement in the ad pod comprised of multiple advertisements, the ad insertion module 204 may insert multiple different combinations of advertisements into the SDV stream 130.

As discussed above, the SDV stream 130 may be broadcast with default advertisements contained in the ad opportunities 302. In the event that the ad playlist 210 has not been located, the ad insertion module 204 may abort the ad insertion for the output streams associated with the missing ad playlist 210 and may thus deliver the default advertisements in the modified SDV stream 220 to the STBs 118. Alternatively, the ad insertion module 204 may request the ad playlist 210 from the ERM 116 (or directly from the switched video manager 104) and may insert the alternative advertisements in the ad opportunities 302 based upon the ad playlist 210.

The edge QAM 114 may report the results of the ad insertions to the ERM 116 (or directly to the switched video manager 104). In any regard, the switched video manager 104 may track this information for ad reporting purposes. The results are also reported to the ad decision service 102 along with the subscribers that received each of the alternative advertisements. This allows the ad decision service 102 to assign a different set of alternative advertisements to those subscribers at the ad opportunity 302 that next arrives.

According to an embodiment, if the switched video manager 104 removes the SDV channel from the service group while tuned to a particular ad stream 140, the switched video manager 104 may delay removal of the advertisements contained in the ad stream 140 so that if the subscriber retunes to the SDV channel, the edge QAM 114 continues to deliver the alternative advertisements from the ad playlist 210.

In addition, the edge QAM 114 may store the ad playlist 210 until an ad pod terminates. When the subscriber tunes back to the SDV channel before the ad pod completes, the switched video manager 104 directs the edge QAM 114 to bind the SDV channel to the service group. The edge QAM 114 may also immediately tune to the ad stream 140 specified in the ad playlist 210. When the ad pod terminates, the edge QAM 114 tunes back to the SDV stream 130 carrying the SDV channel.

Since many channels delivered through SDV streams 130 are “long tail” content, that is, content viewed by statistically few subscribers, each SDV channel may be viewed by a single viewer or a small set of viewers in each service group. Since a different edge QAM 114 is used for each service group, the number of viewers on any of the modified SDV streams 220 will likely be small. Given sufficient unused bandwidth, the content delivery system 100 may assign subscribers to their own copy of an SDV channel even if another viewer in the same service group watches the same channel. This is referred to as opportunistic Switched Unicast. These features allow the content delivery system 100 to deliver highly precise sets of advertisements for each of the modified SDV streams 220.

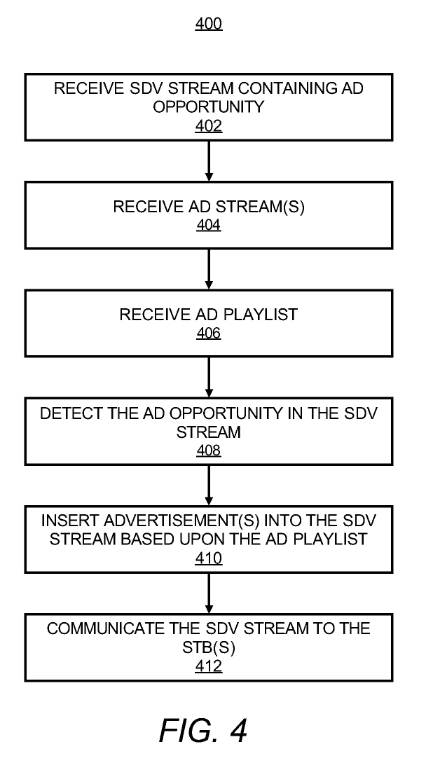

Turning now to FIG. 4, there is shown a flow diagram of a method 400 of providing targeted advertisements to at least one set top box (STB) 118 from an edge QAM 114, according to an embodiment of the invention. It should be understood that the method 400 depicted in FIG. 4 may include additional steps and that some of the steps described herein may be removed and/or modified without departing from a scope of the method 400.

At step 402, the input module 202 of the edge QAM 114 receives an SDV stream 130 containing an ad opportunity 302. In addition, at step 304, the input module 202 receives at least one ad stream 140 containing a plurality of alternative advertisements. Moreover, at step 306, the input module 202 receives an ad playlist 210 that contains a list of one or more of the plurality of alternative advertisements to be inserted into the SDV stream 130 for output to the STB(s) 118.

At step 408, the ad insertion module 204 detects the ad opportunity marker of an ad opportunity 302, which is embedded in the SDV stream 130. In addition, at step 410, the ad insertion module 204 inserts one or more alternative advertisements from the ad stream(s) 140 into the SDV stream 130 at the ad opportunity 302 based upon the ad playlist 210. Moreover, at step 412, the output module 206 outputs the SDV stream 220 to the at least one STB 118.

The method 400 has been described with the SDV stream 130 being modified to include the alternative advertisements prior to the outputting of the modified SDV stream 220 to the STB(s) 118. In this regard, the edge QAM 114 may include a buffer (not shown) for storing at least a portion of the SDV stream 130 and the ad stream 140. In another embodiment, however, the edge QAM 114 inserts the alternative advertisements during the ad opportunities 302 as the SDV stream 130 is communicated to the STB(s) 118.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

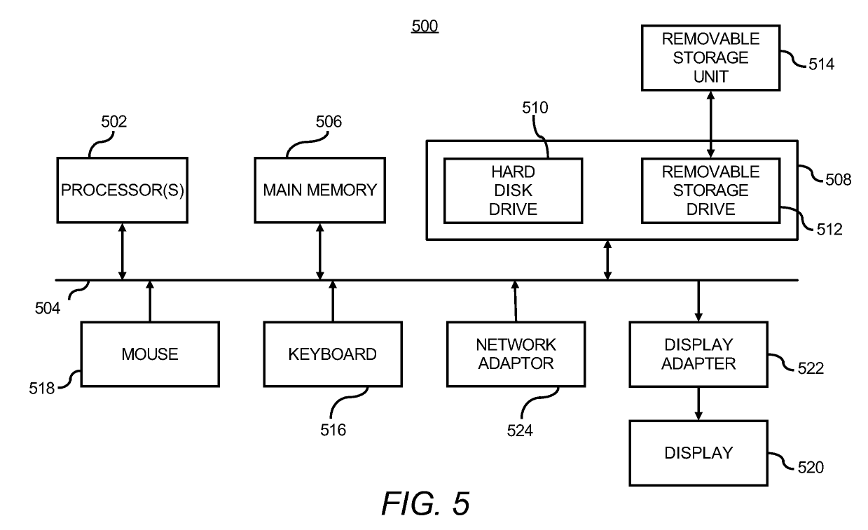

FIG. 5 illustrates a block diagram of a computing apparatus 500 configured to implement or execute one or more of the processes depicted in FIGS. 1-4, according to an embodiment. It should be understood that the illustration of the computing apparatus 500 is a generalized illustration and that the computing apparatus 500 may include additional components and that some of the components described may be removed and/or modified without departing from a scope of the computing apparatus 500.

The computing apparatus 500 includes a processor 502 that may implement or execute some or all of the steps described in one or more of the processes depicted in FIGS. 1-4. Commands and data from the processor 502 are communicated over a communication bus 504. The computing apparatus 500 also includes a main memory 506, such as a random access memory (RAM), where the program code for the processor 502, may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc., where a copy of the program code for one or more of the processes depicted in FIGS. 1-4 may be stored.

The removable storage drive 510 reads from and/or writes to a removable storage unit 514 in a well-known manner. User input and output devices may include a keyboard 516, a mouse 518, and a display 520. A display adaptor 522 may interface with the communication bus 504 and the display 520 and may receive display data from the processor 502 and convert the display data into display commands for the display 520. In addition, the processor(s) 502 may communicate over a network, for instance, the Internet, LAN, etc., through a network adaptor 524.

It will be apparent to one of ordinary skill in the art that other known electronic components may be added or substituted in the computing apparatus 500. It should also be apparent that one or more of the components depicted in FIG. 5 may be optional (for instance, user input devices, secondary memory, etc.).

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. An edge quadrature amplitude modulator (QAM) comprising:
an input module configured to receive a switched digital video (SDV) stream containing at least one ad opportunity, at least one ad stream containing a plurality of alternative advertisements, and an ad playlist that contains a list of one or more of the plurality of alternative advertisements to be inserted into the SDV stream;
an ad insertion module configured to detect the at least one ad opportunity in the SDV stream and to insert one or more of the plurality of alternative advertisements in the at least one ad stream based upon the ad playlist into the SDV stream at the at least one ad opportunity; and
an output module configured to send the SDV stream and the one or more alternative advertisements to at least one STB.

2. The edge QAM according to claim 1, wherein the output module is configured to output the SDV stream and the one or more alternative advertisements in the at least one ad opportunity of the SDV stream substantially as the input module receives the SDV stream and the at least one ad stream. This is its

3. The edge QAM according to claim 1, wherein the at least one ad opportunity comprises an opportunity for multiple advertisements to be inserted into the SDV stream and wherein the ad insertion module is further configured to insert the multiple advertisements into the SDV stream at the at least one ad opportunity.

4. The edge QAM according to claim 3, wherein the multiple advertisements are contained in a plurality of ad streams and wherein the ad insertion module is configured to select the multiple advertisements from the plurality of ad streams.

5. The edge QAM according to claim 3, wherein the ad insertion module is configured to select the multiple advertisements from a single ad stream.

6. The edge QAM according to claim 1, wherein the ad insertion module is configured to receive an indication of the at least one ad opportunity from a groom and splice component.

7. The edge QAM according to claim 1, wherein the ad insertion module is configured to detect an ad opportunity marker indicating a position of the at least one ad opportunity in the SDV stream.

8. The edge QAM according to claim 1, wherein the at least one ad stream comprises one of an IP unicast and an IP multicast stream.

9. The edge QAM according to claim 1, wherein the input module is configured to receive the SDV stream from one of a unicast and a joined multicast IP stream.

10. A system for providing targeted advertisements to at least one set top box (STB), said system comprising:
at least one edge quadrature amplitude modulator (QAM) configured to provide a switched digital video (SDV) stream to the at least one STB, wherein the SDV stream contains at least one ad opportunity;
a groom and splice component configured to supply the SDV stream to the at least one edge QAM;
an ad decision service configured to generate an ad playlist for the at least one STB;
an ad server configured to provide at least one ad stream containing a plurality of alternative advertisements to the groom and splice component, wherein the groom and splice component is further configured to supply the at least one ad stream to the at least one edge QAM; and
wherein the at least one edge QAM is further configured to detect the at least one ad opportunity in the SDV stream, to insert one or more of the plurality of alternative advertisements in the at least one ad stream into the SDV stream based upon the ad playlist at the at least one ad opportunity and to output the SDV stream and the one or more alternative advertisements to the at least one STB.

11. The system according to claim 10, further comprising:
an SDV manager configured to receive an SDV stream request from the at least one STB, to request an ad playlist from the ad decision service based upon the SDV stream request and to provide the ad playlist to the at least one edge QAM.

12. The system according to claim 11, wherein the at least one edge QAM is configured to report information pertaining to the one or more alternative advertisements that have been inserted into the SDV stream to the SDV manager, the SDV manager is configured to report the information to the ad decision service, and the ad decision service is configured to assign ad playlists for the at least one STB based on the reported information.

13. The system according to claim 10, wherein the edge QAM is further configured to output the SDV stream and the one or more alternative advertisements in the at least one ad opportunity of the SDV stream substantially as the edge QAM receives the SDV stream and the at least one ad stream.

14. The system according to claim 10, wherein the groom and splice component is further configured to time the supply of the at least one ad stream to the edge QAM to cause the alternative advertisements contained in the at least one ad stream to substantially coincide with the timing of the at least one ad opportunity in the SDV stream.

15. The system according to claim 10, wherein the at least one edge QAM comprises:
an input module configured to receive the SDV stream, to receive the at least one ad stream, and to receive the ad playlist;
an ad insertion module configured to detect the at least one ad opportunity in the SDV stream and to insert one or more of the plurality of alternative advertisements based upon the ad playlist into the SDV stream at the at least one ad opportunity; and
an output module configured to send the SDV stream with the inserted one or more alternative advertisements to at least one STB.

16. The system according to claim 10, wherein the at least one ad opportunity comprises an opportunity for multiple alternative advertisements to be inserted into the SDV stream, wherein the multiple alternative advertisements are contained in a plurality of ad streams, and wherein the at least one edge QAM is configured to select the multiple alternative advertisements from the plurality of ad streams.

17. A method of providing targeted advertisements to at least one set top box (STB) from an edge quadrature amplitude modulator (QAM), said method comprising steps performed in the edge QAM of:
receiving a switched digital video (SDV) stream containing at least one ad opportunity;
receiving at least one ad stream containing a plurality of alternative advertisements;
receiving an ad playlist that contains a list of one or more of the plurality of alternative advertisements to be inserted into the SDV stream;
detecting the at least one ad opportunity in the SDV stream;
inserting one or more of the plurality of alternative advertisements in the at least one ad stream based upon the ad playlist into the SDV stream at the at least one ad opportunity; and
communicating the SDV stream and the one or more alternative advertisements to at least one STB.

18. The method according to claim 17, wherein inserting the one or more of the plurality of alternative advertisements further comprises inserting multiple alternative advertisements of the plurality of alternative advertisements into the SDV stream, wherein the multiple alternative advertisements are contained in a plurality of ad streams.

19. The method according to claim 17, wherein communicating the SDV stream and the one or more alternative advertisements to at least one STB further comprises communicating the SDV stream and the one or more alternative advertisements to the at least one STB substantially as the edge QAM receives the SDV stream and the at least one ad stream.

20. A computer readable storage medium on which is embedded one or more computer programs, said one or more computer programs implementing a method of providing targeted advertisements to at least one set top box (STB) from an edge quadrature amplitude modulator (QAM), said one or more computer programs comprising a set of instructions for:
receiving a switched digital video (SDV) stream containing at least one ad opportunity;
receiving at least one ad stream containing a plurality of alternative advertisements;
receiving an ad playlist that contains a list of one or more of the plurality of alternative advertisements to be inserted into the SDV stream;
detecting the at least one ad opportunity in the SDV stream;
inserting one or more of the plurality of alternative advertisements in the at least one ad stream based upon the ad playlist into the SDV stream at the at least one ad opportunity; and
communicating the SDV stream with the inserted one or more alternative advertisements to at least one set top box.
